(19) United States
(12) Patent Application Publication
(10) Pub. No.: US 2026/0037936 A1
(43) Pub. Date: Feb. 5, 2026

(54) METHODS AND DEVICES FOR SETTLING CRYPTOCURRENCY TRANSACTIONS

(71) Applicant: Signify Holdings, Inc., New York, NY (US)

(72) Inventors: Yoon Kwan Kim, Brooklyn, NY (US); Charles Naut, Brooklyn, NY (US); Farooq Malik, San Antonio, TX (US)

(21) Appl. No.: 18/792,441

(22) Filed: Aug. 1, 2024

(51) Int. Cl. G06Q 20/06; G06Q 20/36; G06Q 20/40

(52) U.S. Cl. CPC G06Q 20/065; G06Q 20/36; G06Q 20/401

(57) ABSTRACT

A method for settling cryptocurrency transactions, comprising entering a smart contract, on a crypto currency network, between a user and a service provider account (SPA), and another smart contract between the SPA and a merchant, the SPA associated with a service provider. Method may include determining whether to approve the amount for the transaction based on spending power associated with the user, the spending power calculated as a wallet balance associated with a user minus a card balance associated with the user, approving the request from the merchant based on the determined approval, updating, the card balance associated with the user and a merchant account balance, based on approving the amount for the transaction, and forwarding a new transaction request to the crypto-currency network to execute the smart contract, and initiating a token transfer on the cryptocurrency network by executing the smart contract.

### TECHNICAL FIELD

The present disclosure relates generally to blockchain supported transaction environments, and in particular, relates to system and methods for clearing multiple transactions between receptive merchants and respective users in a singular instance.

### BACKGROUND

Conventionally, payment processing systems play a crucial role in modern commerce, facilitating transactions between consumers and merchants. Traditional systems, however, are often complex and inefficient, requiring coordination among multiple entities and relying on fiat currencies. Additionally, based on each transaction, transaction related amounts have to be conventionally settled in fiat currency.

With cryptocurrency, current approaches require constant conversion and transformation into fiat currency when being used by a user across various merchants. Accordingly, there is a need for approaches that allow for cryptocurrency to be utilized in commerce in efficient ways that minimize cost of using cryptocurrency. Exemplary embodiments allow for settling multiple cryptocurrency transactions in an efficient way.

### SUMMARY

An object of the invention is to provide a method for settling cryptocurrency transactions, comprising entering a smart contract, on a crypto currency network, between a user and a service provider account (SPA), entering another smart contract, on the crypto currency network, between a merchant and the SPA, receiving, at one or more processors associated with a Service Provider, from one or processors associated with a merchant, a request from a merchant to approve an amount for a transaction, determining, by the one or more processors associated with the service provider, whether to approve the amount for the transaction based on spending power associated with the user, the spending power calculated as a wallet balance associated with a user minus a card balance associated with the user, approving, utilizing the one or more processors associated with the Service Provider, the request from the merchant based on the determined approval, updating, utilizing the one or more processors, the card balance associated with the user and a merchant account balance, based on approving the amount for the transaction, forwarding a new transaction request and another transaction request to the crypto-currency network, from the one or more processors associated with the Service Provider, to execute the smart contract and the another smart contract, and initiating a token transfer and another token transfer, on the cryptocurrency network, by executing the smart contract and the another smart contract.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for the purpose of illustration and description only and are not intended as a definition of the limits of the present disclosure. Embodiments of the present disclosure will now be described by way of example in association with the accompanying drawings in which:

FIG. 1 is a block-diagram illustrating multiple components that are provided within a cryptocurrency transaction environment, consistent with one of more exemplary embodiments of the present disclosure;

FIG. 2 discloses a flowchart for a method for settling cryptocurrency, consistent with one or more exemplary embodiment of the present disclosure;

FIG. 3 discloses a flowchart for another method for settling cryptocurrency, consistent with one or more exemplary embodiment of the present disclosure; and

FIG. 4 depicts a block diagram of an example computer system in which various of the embodiments described herein may be implemented, consistent with one of more exemplary embodiments of the present disclosure.

### DETAILED DESCRIPTION

Embodiments of the present invention pertain to conducting transactions for the exchange of goods and/or services utilizing debit cards linked with cryptocurrency. While the examples herein may use a specific cryptocurrency for illustration, it should be noted that these examples may apply to any suitable cryptocurrency, including but not limited to Bitcoin, Litecoin, Ethereum, Dash, Ripple, and Monero.

In a first exemplary scenario, to initiate a transaction, users, merchants, and a service provider may enter an exemplary smart contract. In an exemplary embodiment, the exemplary smart contract may be provided by an exemplary service provider. In an exemplary embodiment, smart contract may allow a certain amount of tokens to be committed by one or more exemplary users to the exemplary smart contract, that is, at times of settlement of a plurality of transactions (between at least one user and at least one merchant) based on an exemplary smart contract, up to the committed amount of tokens may be retrieved from an exemplary user, such as retrieving, from an exemplary user wallet. In an exemplary embodiment, committed amount of tokens may correspond to an amount of credit balance or a usable credit that may be associated with an exemplary user. In an exemplary embodiment, a service provider may receive a processing or initiating fee during settlement. In an exemplary embodiment, processing or initiating fee may be a fee that may be tied to an exemplary service provider providing an exemplary smart contract or managing/initiating settlement on-chain. In an exemplary embodiment, one or more merchants may enter an exemplary smart contract to ensure that certain amount of committed tokens equivalent to an exemplary merchant balance may be transferred the exemplary merchant at time of settlement. In an exemplary embodiment, allowing for settlements of multiple transactions in a single instance instead of settling at each transaction may allow for saving “gas fee” In an exemplary embodiment, gas fee may refer to a fee necessary to perform a transaction on blockchain networks.

In a second exemplary scenario, to initiate a transaction, exemplary users and a service provider may enter an exemplary first smart contract, while exemplary merchants and the exemplary service provider may enter another smart contract. In an exemplary embodiment, for an exemplary first smart contract, exemplary users may approve token withdrawals to an exemplary Service Provider's account address using the ERC-20 approve function. Accordingly, exemplary first smart contract may allow for transfer of cryptocurrency between an exemplary service provider and an exemplary user, while an exemplary another smart contract may allow for transfer of cryptocurrency between an exemplary service provider and an exemplary merchant.

In both exemplary scenarios, initially, a user may access a website hosted by an external Service Provider to establish a cryptocurrency account. In an exemplary embodiment, exemplary cryptocurrency account for a user may be linked to a payment device, such as a debit card. In an exemplary embodiment, exemplary merchants may also be able to establish cryptocurrency accounts with an exemplary Service Provider. In an exemplary embodiment, a Service Provider may refer to an entity which may allow users, entities, and merchants to setup cryptocurrency accounts, including those that are associated with an issued debit card. In an exemplary embodiment, a Service Provider may have a Service Provider Account (SPA) within an exemplary cryptocurrency network which it may be able to control. In an exemplary embodiment, SPA may be one of an Externally Owned Account or an exemplary smart contract. As such, a Service Provider (SP) may be able to communicate with card processors or card networks to approve or refuse transactions at a point-of-sale device at an exemplary merchant's based on information related to an exemplary user corresponding to a particular debit card or a particular account. Furthermore, a Service Provider may further have a crypto wallet, communication with crypto-exchanges, and ability to communicate a cryptocurrency network, which may allow it to enter smart contracts or make transactions on an exemplary cryptocurrency network.

As discussed above, an exemplary user may enter a smart contract with a Service Provider to provide it access to its tokens. In an exemplary embodiment, entering a smart contract may be done as in the first exemplary scenario, or it may be done so as done in the second exemplary scenario, for example, by acquisition of an ERC-20 token. For example, a user may acquire USDC, which is a digital stablecoin pegged to the United States Dollar. In an exemplary embodiment, USDC may be available as an Ethereum ERC-20 token, and on blockchains including Hadera Hasgraph, Algorand, Avalanche, Solana, Stellar, Polygon, and TRON. In an exemplary embodiment, ERC-20 tokens standards allow for fungible tokens on the Ethereum blockchain, that is, ERC-20 tokens allow for functionality as smart contracts that are included within their protocols.

In an exemplary embodiment, a user may hold existing cryptocurrency (e.g., Ethereum) into their wallet. Alternatively, they may hold ERC-20, TRC-20, BEP-20, ERC1155 compliant tokens by acquiring ERC-20 tokens.

In an exemplary embodiment, an exemplary merchant may also enter a contract or have a generalized relationship with Service Provider where Service Provider may be able to transfer cryptocurrency into a wallet associated with a cryptocurrency. In an exemplary embodiment, as discussed above, in the first exemplary scenario, an exemplary smart contract may have a user and an exemplary service provider may also be part of an exemplary smart contract, while in the second exemplary scenario, an exemplary merchant may have a smart contract only with an exemplary service provider for such transfer. In an exemplary embodiment, exemplary Service Provider may manage an account balance related to an exemplary Merchant which it may settle as required.

Accordingly, in an exemplary embodiment, once a Service Provider (which may have issued a debit card to a user) receives a request for fiat currency approval from an exemplary card processor, an exemplary Service Provider may ascertain whether a corresponding balance (user balance amount remaining) based on amount of cryptocurrency designated to the transferred to an exemplary Service provider from an exemplary user based on an exemplary smart contract which entered at least between an exemplary Service Provider and a user, that is, an exemplary smart contract may also be entered between additional an exemplary merchant.

For instance, an exemplary user may present a payment device (e.g., a debit card) at a merchant to initiate a transaction. In an exemplary embodiment, a transaction may be initiated on a website or a Point-of-Sale (POS) device associated with an exemplary merchant. In an exemplary embodiment, an exemplary merchant may also utilize an exemplary POS device but also may have an exemplary merchant account or wallet within an exemplary block chain.

In an exemplary embodiment, an authorization request message may be sent by a POS device (or generally by an exemplary merchant associated server), containing the user's payment credentials (e.g., debit card number, payment account number) and specifying the transaction amount in fiat currency, may be transmitted to a computer of the Service Provider following a conventional procedure. Upon receiving an exemplary authorization request message, the exemplary Service Provider's computer verifies that the payment device mentioned in the request is linked to a user contained within an exemplary database of the Service Provider. In an exemplary embodiment, an exemplary computing systems associated with an Service Provider may check information related to a user in an exemplary database, including, for example, a user's cryptocurrency account balance, may calculate the cryptocurrency equivalent of the fiat currency amount based on the current exchange rate, determine if an exemplary balance exists where the amount may be approved, and may update internal records within an exemplary SP server regarding an account total for the user and the merchant. In an exemplary embodiment, an exemplary Service Provider may settle both a user account and merchant account periodically. In detail, as described above, Service Provider may be able to settle a smart contract, via a cryptocurrency network, which may lead to an exemplary user transferring a corresponding amount of cryptocurrency (up to a committed amount) from its exemplary wallet based on information about a user account on a periodical basis. As an illustrative exemplary scenario, two users may conduct multiple transactions across three merchants. Based on each transaction, account balances dealing with the respective user and the respective merchant may be updated by the Service Provider, but a singular cryptocurrency transaction may occur for each merchant and each user encompassing all underlying transactions on a periodical basis, for example, each day, week, month, or any other period. Alternatively, a singular transaction may occur which may settle all underlying transactions for exemplary users and exemplary merchants.

Exemplary methods and systems described enhance the practicality of using cryptocurrency for transactions by minimizing transactional fees associated with cryptocurrency usage, for example, in conventional methods, based on each transaction, there are costs associated with each transfer of tokens from one entity to another. However, by minimizing the amount of token transfers for a plurality of transactions, a reduced amount of fees are charged in the aggregate for the transfers, thereby, saving gas fee.

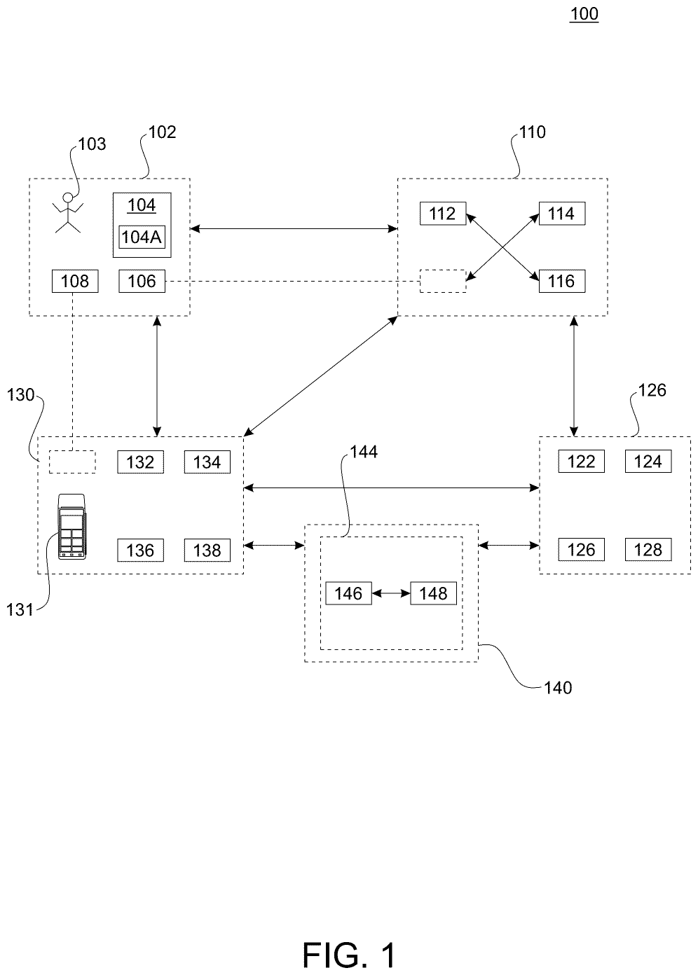

In an exemplary embodiment, FIG. 1 is a block-diagram illustrating multiple components that are provided within cryptocurrency transaction environment, consistent with one of more exemplary embodiments of the present disclosure. In detail, FIG. 1 shows a block diagram of system 100 for settling a plurality of transactions utilizing cryptocurrency. System 100 may comprise a user related environment 102, crypto currency network 110, Service Provider environment 120, merchant environment, 130 and financial institutional environment 140. One of ordinary skill in the art would understand that elements listed within an element may be present in other elements but are illustrated as such for explaining the functionality consistent with exemplary embodiments. Please note that respective user related environments 102, Service Provider environment 120, merchant environment 130, and financial institutional environment 140 are just illustrative comprising elements contained within to provide clarity regarding functionality and association between different elements but are not meant to be restrictive to being in physically distinctive spaces.

In an exemplary embodiment, user related environment 102 may include user 103, user device 104 which may be associated with user 103, user wallet 106, and debit card 108.

In an exemplary embodiment, user 103 may refer to an individual or an individual/individuals acting on behalf of an entity. In some embodiments, an exemplary user may be associated with one or more personal accounts (at an exemplary Service Provider) and/or mobile devices. In an exemplary embodiment, user may also be referred to as a cardholder, account holder, or consumer associated with debit card 108. In an exemplary embodiment, debit card 108 may be issued by an exemplary Service Provider and may correspond to an exemplary account for an exemplary user, information related to which may be stored by a Service Provider. In an exemplary embodiment, debit card 108 may be a debit card which may allow a user to conduct a financial transaction, such as to provide payment credentials to a merchant. For example, it may be a card with a magnetic strip or credentials may be uploaded in software form such as utilizing various mechanisms to pay utilizing Bluetooth technology. In an exemplary embodiment, debit card 108 may contain information encoded within it or contained within it to provide information associated with an account (e.g., a payment account and/debit card associated with the account by a Service Provider). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CW and dCW values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

In an exemplary embodiment, user device 104 may comprise any suitable electronic device that may be transported and operated by user 103, which may also provide remote communication capabilities to an exemplary network. Examples of remote communication capabilities include using a mobile phone (wireless) network, wireless data network (e.g. 3G, 4G or similar networks), Wi-Fi, Wi-Max, or any other communication medium that may provide access to an exemplary network such as the Internet or a private network. Examples of user devices include mobile phones (e.g. cellular phones), PDAs, tablet computers, net books, laptop computers, personal music players, hand-held specialized readers, etc. Further examples of user devices include wearable devices, such as smart watches, fitness bands, ankle bracelets, rings, earrings, etc., as well as automobiles with remote communication capabilities. An exemplary user device, such as, user device 104, may comprise any suitable hardware and software for performing such functions, and may also include multiple devices or components (e.g., when a device has remote access to a network by tethering to another device—i.e., using the other device as a modem—both devices taken together may be considered a single user device). In an exemplary embodiment, user device 104 may have stored thereon on one or more computer storage mediums, an application 104A, which may comprise computer code or other data stored on a computer readable medium (e.g. memory element or secure element) that may be executable by a processor to complete a task. In an exemplary embodiment, user device 104 may allow for a user to conduct transactions with various processors, including allowing a user to enter agreements, access websites, buy cryptocurrency, etc.

In an exemplary embodiment, user device 104 may simply be used to make a transaction with an exemplary without using a debit card 108 by simply using information related to an account number that may be associated by an exemplary merchant. In an exemplary embodiment, account number information may allow an exemplary service provider to associate a crypto wallet with a user, and an exemplary user account.

In an exemplary embodiment, user wallet 106 may refer to a crypto wallet. In an exemplary embodiment, crypto wallet may refer to a device, physical medium, program or a service which stores the public and/or private keys for cryptocurrency transactions. In an exemplary embodiment, user wallet 106 may be an on-chain digital wallet (and thus would alternatively be part of cryptocurrency network 110) associated with a user. In an exemplary embodiment, a cryptocurrency wallet may also offer the functionality of encrypting and/or signing information. In an exemplary embodiment, signing information may result in executing a smart contract. In an exemplary embodiment, keys to any cryptocurrency or tokens that may be stored in user wallet may be acquired by transfer from another individual or entity. Alternatively, user 104 may acquire tokens or cryptocurrency utilizing an exemplary exchange. In an exemplary embodiment, an exemplary exchange may refer to an entity that facilitates exchanges of cryptocurrency and fiat currency between parties. The exchange may manage any suitable number of accounts associated with registered parties. Users that wish to sell cryptocurrency may conduct a cryptocurrency transaction to transfer their cryptocurrency to the exchange and the exchange may manage the cryptocurrency on behalf of the user. Users may additionally, or alternatively, transfer fiat currency to the exchange and the exchange may manage the users' fiat currency within the exchange. A user may provide the exchange a “buy request” indicating that the user wishes to purchase a particular amount of cryptocurrency for a particular amount (or within a range of the particular amount) of fiat currency. Users may also provide the exchange a “sell request” indicating that the user wishes to sell cryptocurrency for a particular amount (or within a range of the particular amount) of fiat currency. The exchange may be configured to match a buy request to a sell request in order to identify a buyer that is willing to purchase cryptocurrency at the fiat currency amount (or within the range) at which the seller is interested in selling. If a match is found, the exchange can facilitate a transfer of the fiat currency from the buyer's account within the exchange to the seller's account within the exchange. In an exemplary embodiment, an exemplary exchange may also facilitate the transfer of the cryptocurrency from the seller's account within the exchange to the buyer's account within the exchange.

In an exemplary, user 103 may be able to use the user device 104 to create and/or manage a cryptocurrency account, interact with smart contracts, etc. In an exemplary embodiment, interacting with smart contracts may entail entering into one, agreeing to one, etc. By way of example, the user 103, utilizing application 104A operating on the user device 104 may access a website hosted by an exemplary server computer (not shown) that may be configured to host a website on behalf of a Service Provider (e.g., an issuer off debit card 108). Through an exemplary application within user device 104 (e.g., a wallet application, a browser application, etc.), an exemplary server may provide any suitable number of interfaces to enable the user 103 to create a cryptocurrency account and/or to modify an existing cryptocurrency account.

In an exemplary embodiment, cryptocurrency network 110 may include one or more computers (not illustrated) that participate in maintaining a cryptocurrency ledger 112. Additionally, cryptocurrency network 110 may include a Service Provider Account 114 and a merchant wallet 116. As discussed above, user wallet 106 associated with user 103 may be a part of cryptocurrency network 110 as well, that is, user wallet 106 may be on chain. In an exemplary embodiment, a cryptocurrency ledger 112 may comprise a blockchain. In an exemplary embodiment, a blockchain may be a decentralized and distributed digital ledger that may be used to record transactions across many computers so that the record cannot be altered retroactively without the alteration of all subsequent blocks and the collusion of the network. Examples of a cryptocurrency network may include networks of computers that manage any suitable cryptocurrency including, but not limited to, Bitcoin, USDC, Litecoin, Ethereum, Dash, Ripple, and Monero. In an exemplary embodiment, Ethereum network may be utilized.

In an exemplary embodiment, Service Provider Account (SPA) 114 may comprise an account associated with an exemplary Service Provider, and which may represent an account controlled by a private key and owned by an external (to cryptocurrency network 110) entity, specifically, an exemplary Service Provider. In an exemplary embodiment, SPA 114 may be a Service Provider Account configured to be compatible with an Ethereum Virtual Machine. In an exemplary embodiment, SPA 114 (or exemplary smart contracts within cryptocurrency network 110) may be able to hold either native token from chain, such as Ethereum (ETH), or tokens from ERC-20 smart contract, such as USDC.

In an exemplary embodiment, merchant wallet 116 may be an exemplary merchant associated with an exemplary merchant which may functional similar to an exemplary on-chain user wallet 106 or SPA 114 and maybe able to hold or receive cryptocurrency tokens.

In an exemplary embodiment, Service Provider environment 120 may include Service Provider processor 122, Service Provider wallet 124, Service Provider databases 126, and Service Provider fiat account 128.

In an exemplary embodiment Service Provider environment 120 may be associated with a Service Provider. In an exemplary embodiment, an exemplary Service Provider may have issued debit card 108 to user 103 and may have created an associated account at a Service Provider for an exemplary user and corresponding debit card. In an exemplary embodiment, this exemplary account and corresponding debit card may allow for transactions based on a user's cryptocurrency holdings.

In an exemplary embodiment, Service Provider processor 122 may comprise of one or more processors that are configured to manage all functionalities needed for operations of a Service Provider. In an exemplary SP processor 122 may allow for interactions with cryptocurrency network 110, communicate with external devices, execute internal codebase, access databases, access other websites and SAAS services. Additionally, in an exemplary embodiment, AE processor 122 may allow a user representing an SP or an automated system to access data, use third-party crypto exchanges to convert cryptocurrency to fiat currency and vice-versa.

In an exemplary embodiment, SP wallet 124 may not be necessary due to presence of SPA 114 which may be able to send and receive cryptocurrency (such as ETH) and interact with smart contracts.

In an exemplary embodiment, Service Provider wallet 124 may refer to a local crypto wallet associated with an exemplary Service Provider. In functionality, it may be similar to user wallet 106. In an exemplary embodiment, SP wallet 124 may contain keys associated with tokens or cryptocurrencies for a Service Provider. These may be received from various exemplary users or various crypto exchanges to which an exemplary Service Provider may interact with utilizing SP processor 122. Additionally, in an exemplary embodiment, SP wallet 124 may be able to hold tokens that may be retrieved from SPA 114.

In an exemplary embodiment, Service Provider databases 126 may refer to one or more exemplary databases which may contain information related to an exemplary Service Provider. In an exemplary embodiment, exemplary databases may be used to store information related to various user accounts, their corresponding debit cards, including any smart contracts or corresponding crypto wallets for the exemplary users. In an exemplary embodiment, databases may include information needed to verify debit cards and furthermore. In an exemplary embodiment, exemplary databases may store further information related to funds available for each user, history of all funds associated with such user, exchange rates between various cryptocurrencies and fiat currency, information related to fiat holdings of the Service Provider, information needed to authenticate, communicate, and interact with any crypto exchanges or exemplary financial institutions. Additionally, in an exemplary embodiment, SP databases 126 may additionally include information related to SPA 114 including its holdings, how to access, and code to access SPA 114.

In an exemplary embodiment, databases 126 may further contain information about each user, merchant, and all transactions. In an exemplary embodiment, for each respective user, information may be stored about associated wallet balances and user account balances. In an exemplary embodiment, wallet balance may refer to an amount of cryptocurrency that may be committed to an exemplary smart contract, while an exemplary user account balance (or credit balance) may refer to an accumulation of balances associated with all transactions by an exemplary user. In an exemplary embodiment, merchant account balance may refer to an amount that is owed to a respective merchant. Accordingly, merchant account balance continues to accumulate until it is settled.

In an exemplary embodiment, SP fiat account 128 may be one or more accounts associated with Service Provider that may be fiat currency accounts. In an exemplary embodiment, they may be held at various banking institutions, may be held internally (at the Service Provider if it is a bank or bank-related authority), or may be held at various financial services entities (such as exemplary card processors such as card processor 138). In an exemplary embodiment, a Service Provider may utilize Service Provider processor 122 to move fiat currency between one or more fiat currency accounts. Furthermore, a Service Provider may utilize Service Provider processor 122 to hold fiat currency in one or more fiat currency accounts based on cryptocurrency or tokens. These tokens may be converted utilizing external exchanges or internally based on exchange rates.

In an exemplary embodiment, an exemplary Service Provider (and its associated infrastructure such as SP processor 122) may interact with an exemplary merchant associated with merchant environment 130 or utilizing an exemplary financial institutional environment 140.

In an exemplary embodiment, merchant environment 130 may include merchant point-of-sale (POS) device 131, merchant processor 132, merchant wallet 134, merchant databases 136, and merchant fiat account 138.

In an exemplary embodiment, merchant environment 130 may be associated with an exemplary merchant. In an exemplary embodiment, an exemplary merchant may have an account with an exemplary service provider and may also provide services products to exemplary customers or users who also have created accounts established at an exemplary service provider. In an exemplary embodiment, an exemplary merchant account may be held by an exemplary service provider which may keep records of an amount owed to an exemplary merchant. In an exemplary embodiment, POS device 131 may refer to a point-of-sale device which may be used to process transactions by retail customers. In an exemplary embodiment, in lieu of a POS device 131 transactions may occur between an exemplary merchant and an exemplary customer/user utilizing an account number.

In an exemplary embodiment, merchant processor 132 may comprise of one or more processors that are configured to manage all functionalities needed for operations of a merchant. In an exemplary merchant processor 132 may allow for interactions with user device 104/debit card 108, cryptocurrency network 110, communicate with service provider environment 120, financial institute environment 140, communicate external devices, execute internal codebase, access databases, access other websites and SAAS services. Additionally, in an exemplary embodiment, merchant processor 132 may allow a user representing a merchant or an automated system to access data, use third-party crypto exchanges to convert cryptocurrency to fiat currency and vice-versa.

In an exemplary embodiment, merchant wallet 134 may be an off-chain wallet for holding and receiving cryptocurrencies, but in an exemplary embodiment due to presence of merchant wallet 116 which may be able to send and receive cryptocurrency (such as ETH) and interact with smart contracts, both or only one of exemplary merchant wallets may be present.

In an exemplary embodiment, merchant wallet 134 may refer to a local crypto wallet associated with an exemplary merchant. In functionality, it may be similar to user wallet 106 or SP wallet 124. In an exemplary embodiment, merchant wallet 134 may contain keys associated with tokens or cryptocurrencies for an exemplary merchant. In an exemplary embodiment, keys may be received from various exemplary users, exemplary service provider, or various crypto exchanges to which an exemplary merchant provider may interact with merchant processor 132. Additionally, in an exemplary embodiment, merchant wallet 134 may be able to hold tokens that may be retrieved from merchant wallet 116.

In an exemplary embodiment, merchant databases 136 may refer to one or more exemplary databases which may contain information related to an exemplary merchant. In an exemplary embodiment, exemplary databases may be used to store information related to various user accounts, transactions, information related to smart contracts or corresponding crypto wallets for exemplary service providers, in addition to information about merchant goods and services, including inventory, prices, costs, etc. In an exemplary embodiment, databases 136 may further contain information related to each transaction, including its impact on merchant account balance with an exemplary service provider and total amount due.

In an exemplary embodiment, databases 136 may include information needed to send a request to verify accounts and debit cards and furthermore. In an exemplary embodiment, exemplary databases may store further information needed to authenticate, communicate, and interact with any crypto exchanges or exemplary financial institutions. In an exemplary embodiment, merchant databases 136 may additionally include information related to merchant wallet 116, including its holdings, how to access, and code to access merchant wallet 116.

In an exemplary embodiment, merchant fiat account 138 may be similar to SP fiat account 128, and may function similarly, if a merchant needed to convert its holdings from cryptocurrency to fiat or vice versa.

In an exemplary embodiment, an exemplary merchant (and its associated infrastructure such as merchant processor 132) may interact with an exemplary service provider utilizing an exemplary financial institutional environment 140.

In an exemplary financial institutional environment 140 may include card transaction network 144 which may comprise a card network 146 and card processor 148.

In an exemplary embodiment card transaction network 144 may refer to an environment which may receive a request for approval of a transaction by an exemplary merchant and is able to interact and provide a response from an exemplary authorizing entity, that is, an exemplary entity which may have issued an exemplary debit card, such as, an exemplary Service Provider issuing debit card 108. In an exemplary embodiment card transaction network may further comprise a card network 146 and card processor 148. In an exemplary embodiment, card network 146 may include various networks which integrate exemplary merchants with exemplary banks, such as, Visa®, Master®, Amex®, Discover®, etc, who may in turn pass this information to card processor 148 to seek authorization from an exemplary SPA. In an exemplary embodiment, card network 146 may allow coordinating and governing various communications between various entities and elements, including various financial institutions which are required in confirming a transaction between an exemplary issuing bank and an exemplary merchant.

In an exemplary embodiment card processor 148 may refer to infrastructure and technology related to an exemplary payment service provider, such as Stripe®, and includes all elements needed to complete an exemplary transaction.

In an exemplary embodiment, user device 104, cryptocurrency network 108, debit card 108, POS device 141, SP processors 122, merchant processor 132, and all other elements included within system 100 may be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. In an exemplary embodiment, messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

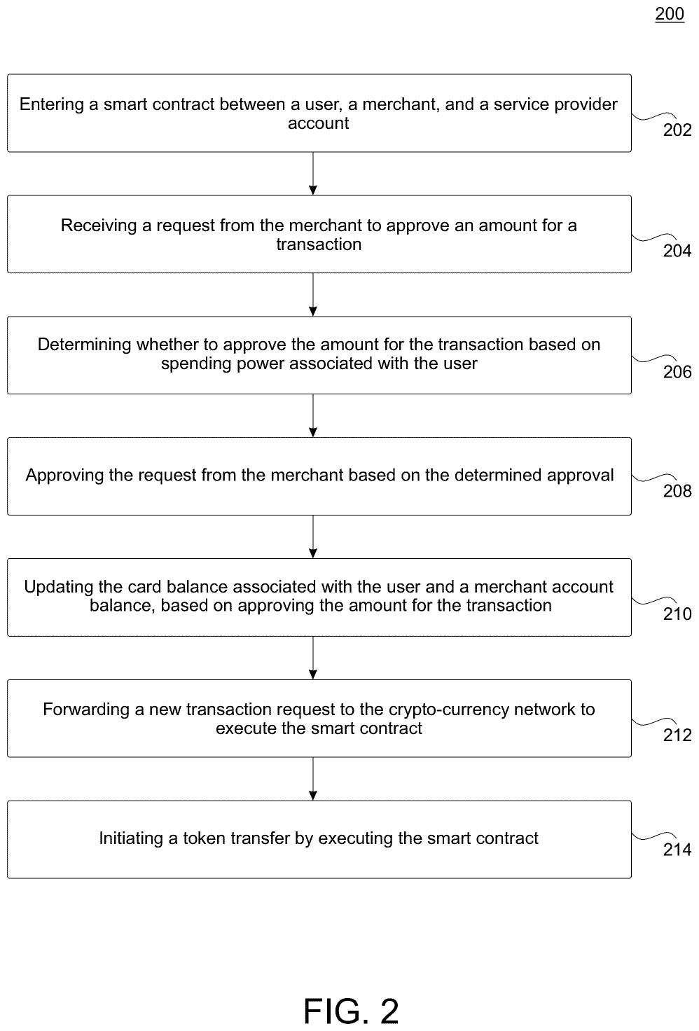

FIG. 2 discloses a flowchart for a method for settling cryptocurrency transactions, consistent with one or more exemplary embodiments of the present disclosure. In an exemplary embodiment, method 200 of FIG. 2 may be understood in the context of elements of system 100 provided in FIG. 1.

In an exemplary embodiment, method 200 may comprise of step 202 which may comprise of entering a smart contract between a user, a merchant, and a service provider account. In an exemplary embodiment, the service provider account may be associated with an exemplary service provider.

In an exemplary embodiment, entering a smart contract may comprise generating the smart contract, on the crypto-currency network, allowing the transfer of a maximum number of tokens from the user's wallet, allowing the transfer of a first number of tokens to a service provider wallet associated with the service provider, and allowing transfer of a second number of tokens to a merchant wallet associated with the merchant at each settlement initiated by an exemplary service provider. In detail, in an exemplary embodiment, a smart contract may provide for a user to allow a maximum number of tokens associated with a user to be withdrawable from a user wallet. Accordingly, in an exemplary embodiment, that maximum number of tokens may be associated with how much a user may charge on an associated account/card, that is, an upper limit. In an exemplary embodiment, an exemplary merchant may also enter an exemplary smart contract allowing it to receive a number of tokens based on a total balance due to an exemplary merchant at an exemplary instance when accounts are to be settled. In an exemplary embodiment, an exemplary Service Provider may have a Service Provider account (SPA) 114 on cryptocurrency network 110. In an exemplary embodiment, an exemplary user may allow Service Provider's SPA to also receive a fee each time accounts are settled for exemplary users and merchant. In an exemplary embodiment, an exemplary smart contract may allow for withdrawing a limited amount of tokens from an exemplary user's wallet by using an exemplary “approve” function in an exemplary smart contract.

In an exemplary embodiment, entering a smart contract may comprise generating the smart contract on the crypto-currency network, which may allow cryptocurrency network 110 to retrieve a maximum number of tokens from a user's wallet to a merchant wallet 116 associated with a merchant, and a Service Provider wallet 124 associated with the Service Provider.

In an exemplary embodiment, generating the smart contract may further comprise of accessing terms of the agreement of the smart contract, utilizing a user device, then inputting acquiescence to the agreement utilizing the user device, and recording the smart contract on a ledger on the crypto-currency network.

In an exemplary embodiment, user device 104 may be utilized to enter into an exemplary smart contract, by entering a specific exemplary smart contract complying with terms as defined above. In an exemplary embodiment, similar devices may be utilized by an exemplary user, exemplary merchant, or exemplary service provider to enter an exemplary smart contract. In an exemplary embodiment, an exemplary service provider may create an exemplary smart contract while an exemplary merchant and exemplary user may simply enter them or agree to them. Accordingly, in an exemplary embodiment, when an exemplary transaction occurs at a merchant, a merchant is assured that based on an exemplary smart contract, an exemplary merchant account will be eventually settled at the time of settlement.

In an exemplary embodiment, method 200 may further comprise of step 204, which may comprise of receiving, at one or more processors associated with a service provider, from one or processors associated with a merchant, a request from the merchant to approve an amount for a transaction. In an exemplary embodiment, an exemplary request may be received directly from processors associated with an exemplary merchant or may be received through one or more processors associated with a card processor. In an exemplary embodiment, in an instance where an exemplary processor associated with an exemplary merchant provides the information, an exemplary user may provide account information (associated with a user) to an exemplary merchant and exemplary merchant may request approval of sale request directly from an exemplary service provider. In an exemplary embodiment, in an exemplary instance when an exemplary request is received from one or more processors associated with an exemplary card processor, in detail this may comprise, receiving, at SP processor 122, from one or processors (not illustrated) associated with card processor 148, a request from a point-of-sale device 131 to approve an amount in fiat currency. In an exemplary embodiment, card processor 148 may request SP processor 122 approval for a transaction on behalf of an exemplary merchant associated with exemplary merchant environment 130 where an exemplary POS device, for example, POS device 131 may be located.

For illustrative purposes, in an exemplary scenario, when user 103 inserts, taps, slides, or otherwise provides their debit card 108 to an exemplary merchant via POS device 131, an exemplary merchant) or merchant's processor collects information related to debit card 108 and then passes that debit card 108 on to the card network 146 (e.g., Visa®, Master®, Amex®, Discover®, etc.) who may in turn pass this information to card processor 148 to seek authorization from Service Provider. Accordingly, on behalf of Service Provider, SP processor 122 may then send authorization results to card network 146, who then sends the authorization results to an exemplary merchant (or merchant's processor) and/or merchant's POS device 131.

In detail, a user 103 may present his/her debit card 108 to an exemplary merchant (not shown) for payment, for example, by either inserting, sliding, or tapping his/her debit card 108 into, through, or on a reading zone of a POS device 131, or may present information related to their debit card 108 to an exemplary merchant in numerous ways, such as presenting a digital wallet, presenting a QR code, inputting the payment card number (particularly for online purchasing), RF transmissions, Bluetooth transmissions, smartphone based card transmissions, and any other form. In an exemplary embodiment, POS device 131 may acquire debit card 108 details as user 103 presents debit card 108 to POS device 131. In an exemplary embodiment, POS device 131 may send information to an exemplary service provider directly or through financial institute environment 140.

In an exemplary embodiment, details regarding debit card 108 may be transmitted to the card network 146. In an exemplary embodiment, card network 146 may request payment authorization from Service Provider by sending a request to Service Provider processors 122. In general, the payment authorization request that card network 146 sends to Service Provider environment 120 includes one or more debit card 108 details such as, e.g., payment card number, payment card expiration date, billing address (for address verification system validation), payment card security code (e.g., CVV), and/or payment amount. These details may be obtained when user 103 presents his/her debit card 108 to an exemplary merchant.

Upon receiving the debit card 108 details from card network 146, SP processors 122 may verify the validity of user 103 debit card 108 using fraud protection tools such as the address verification service and/or card security codes such as CVV, CVV2, CVC2, CID, etc. In an exemplary embodiment, exemplary SP processors 122 may validate the debit card 108 number, check the amount of available funds, match the billing address to the one on file and validates CVV number. Additionally, SP processors 122 may determine an account associated with debit card 108.

In an exemplary embodiment, method 200 may further comprise of step 206, which may comprise of determining, by the one or more processors associated with the service provider, whether to approve the amount for the transaction based on spending power associated with the user. In an exemplary embodiment, the spending power may be calculated as a wallet balance associated with a user minus a card balance associated with the user.

In detail, this may entail determining by SP processor 122 whether to approve the amount for the transaction based on information contained within SP databases 126. Specifically, SP processor 122 may access or calculate spending power associated with an exemplary user. In an exemplary embodiment, an exemplary wallet balance may refer to cryptocurrency that may be committed to an exemplary service provider due to an exemplary smart contract. Accordingly, an amount of cryptocurrency tokens which may not be in service provider custody but is committed to be provided if certain terms are met. In an exemplary embodiment, card balance may refer to an exemplary balance of an exemplary user account. In an exemplary embodiment, an exemplary balance of an exemplary user account may be a combined total of transactions associated with an exemplary user which remained unsettled.

In an exemplary embodiment, method 200 may further comprise step 208. In an exemplary embodiment, step 208 may comprise of approving, utilizing the one or more processors associated with the Service Provider, the request from the merchant based on the determined approval. That is, if the amount associated with the request is less than an exemplary spending power associated with the user, as calculated by SP processor, an exemplary transaction may be approved.

In an exemplary embodiment, in response to determining approval of the transaction, SP processor 122 may provide a decision to an exemplary merchant (and its merchant processor 132 and/or POS device 131) via card processor 148 and card processor 146.

Specifically, in an exemplary embodiment, an exemplary authorization result, generated by SPA processor 126, may include a message that responds to an authorization request. In an exemplary embodiment, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that an exemplary SP processor 126 may return in response to an authorization request message in an electronic message (either directly or through the transaction processing computer) to the merchant's access device (e.g. POS equipment) that indicates approval of the transaction. The code may serve as proof of authorization. As noted above, in some embodiments, a transaction processing computer may generate or forward the authorization response message to an exemplary merchant.

Once authorized, user 103 may then confirm the transaction, for example, by signing a confirmation receipt printed by POS device 131. In an exemplary embodiment, merchant processor 132 may send information related to a final transaction to an exemplary service provider, for example, SP processor 122. Exemplary information, which may include price, user (purchaser), merchant, etc., may be stored within SP databases 126.

In an exemplary embodiment, method 200 may further comprise of step 210, which may comprise updating, utilizing the one or more processors, the card balance associated with the user and a merchant account balance, based on approving the amount for the transaction. In further detail, as described above, based on each transaction, SP processor 122 may update information stored in SP databases 126. This may entail an exemplary card balance associated with a user, that is, a cumulative sum owed by a user to one or more merchants. Furthermore, a merchant account balance associated with a respective merchant may be updated, that is, the amount that is to be settled to that respective merchant.

In an exemplary embodiment, method 200 may further comprise of step 212, which may comprise forwarding a new transaction request to the crypto-currency network, from the one or more processors associated with the Service Provider, to execute the smart contract. In an exemplary embodiment, the new transaction request may be executed to simultaneously withdraw an amount from a user wallet, and transfer a token amount to exemplary merchant wallets, and additional transfer another token amount to exemplary service provider accounts.

In an exemplary embodiment, there may be additional requests associated with various users and additional requests associated with various other merchants. Alternatively, within a smart contract, a plurality of users and a plurality of merchants may be associated, with an exemplary smart contract, so in execution of a smart contract, multiple various tokens may be withdrawn from multiple user and multiple merchants may be paid.

As an exemplary scenario, forwarding a new request may entail forwarding a new transaction request to the crypto-currency network 110, from SP processors 122, to execute the smart contract, wherein executing the smart contract comprises transferring a quantity of tokens corresponding to the amount of the user balance from the user's wallet 106, transferring an amount to merchant wallet 116, and transferring another amount to SPA 114 (corresponding to an exemplary gas fee).

In an exemplary embodiment, SP processors 122 may be configured to (based on software encoded within memory/databases of SP environment 120) to conduct step 212. Accordingly, SP processors 122 may forward a transaction request to crypto currency network 110 based on a pre-defined period or explicit instructions received from SP processor 122.

In an exemplary embodiment, method 200 may further comprise of step 214, which may comprise initiating a token transfer, on the cryptocurrency network, by executing the smart contract. In detail, step 214 may comprise of initiating a token transfer and withdrawing, on the crypto-currency network, the quantity of the tokens corresponding to the user balance from the user's wallet 106, transferring another quantity of tokens associated with merchant account balance to merchant wallet 116, transferring another quantity of tokens to SPA 114 based on fees due to service provider, and updating ledger 112 on crypto-currency network 110.

In further detail, in an exemplary embodiment, SP Processor 122 may initiate a fund transfer on-chain, that is conduct the exchange that was enabled in step 202. In an exemplary embodiment, a fund transfer on-chain may be initiated using Ehters.js lib and infura. In an exemplary embodiment, Ethers.js lib may refer to a JavaScript library that is used in off chain codebase. In an exemplary embodiment, using it enables off chain code to communicate with blockchain such as reading account balance and transfer assets to another account. In an exemplary embodiment, off chain codebase may be stored within SP Environment 120. In an exemplary embodiment, in order for ethers.js to work with blockchain, it needs node provider like Infura. In an exemplary embodiment, Infra runs nodes that is part of blockchain so it can do read/write operation. Programmer can enter Infura credential to ethers.js, pay Infura for read/write operations.

In an exemplary embodiment, exemplary settlement may be performed utilizing an exemplary “settle” function in an exemplary smart contract.

In an exemplary embodiment, one or more computers within cryptocurrency network 110 may execute the “settle” function. In an exemplary embodiment, an exemplary smart contract may have atomicity, that is, in an exemplary embodiment, all operations of transferring of tokens within an exemplary work unit are completed successfully; otherwise, the transaction is aborted at the point of failure, and all the previous operations are rolled back to their former state.

In an exemplary embodiment, in detail, as token transfers to/from an exemplary smart contract happens in an atomic function, either all transfers are done or nothing. Accordingly, in an exemplary embodiment, an exemplary smart contract does not take custody of any tokens. In an exemplary embodiment, an exemplary SPA may only receive tokens corresponding to an exemplary fee that has been earned by an exemplary service provider.

Accordingly, by execution of exemplary smart contracts, tokens are transferred from an exemplary user wallet, to an exemplary SPA associated with an Service Provider (based on an exemplary fee owed), such as SPA 114 and Service Provider associated with SP processors 122, and to an exemplary merchant wallet.

In an exemplary embodiment, updating a ledger on the crypto-currency network may refer to one or more computers within cryptocurrency network 110 updating a ledger, such as cryptocurrency ledger 112.

In an exemplary embodiment, one or more processors associated with a Service Provider, such as SP processors 126, may determine that a transaction has occurred or in exemplary embodiments, that a transaction will occur based on a smart contract or a Service Provider Account, and therefore, update information related to a particular user and corresponding SP account on SP databases 126. This may include, an exemplary amount of corresponding tokens committed to Service Provider, for example, based on token stored at SPA 114 or based on smart contracts. Accordingly, SPA processors 122 may continue to approve or deny transactions requests based on information included within SP databases 126.

In an exemplary embodiment, approvals from SP processors 122 may be sent on data related to SPA 114 and specific users. In such exemplary instances, settlements between user wallet 106 and SPA 114 may occur on a periodical basis, that is, daily, weekly, monthly, or another specified amount of time. In an exemplary embodiment, they may occur when a certain transaction threshold is determined by SP processors 122 based on Service Provider set parameters (which may be stored within SP databases 126). Accordingly, in an exemplary embodiment, transfer of exemplary tokens related to multiple transactions may happen concurrently saving “gas” within cryptocurrency network 110.

In an exemplary embodiment, payment settlements between an exemplary merchant and exemplary Service Provider may occur at the end of a given time. For example, payment settlement may occur at the end of the given time (e.g. the end of the day).

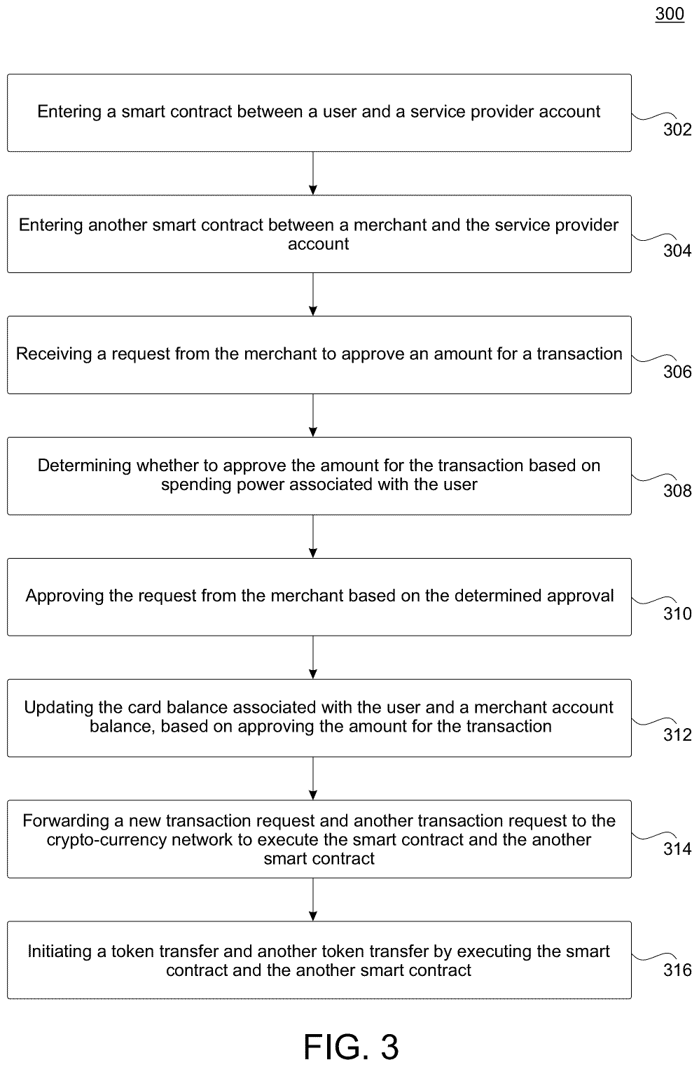

FIG. 3 discloses a flowchart for another method for settling cryptocurrency transactions, consistent with one or more exemplary embodiments of the present disclosure. In an exemplary embodiment, method 300 of FIG. 3 may be understood in the context of elements of system 100 provided in FIG. 1.

In an exemplary embodiment, method 300 may comprise of step 302 which may comprise of entering a smart contract between a user and a service provider account.

In an exemplary embodiment, entering a smart contract may comprise either explicitly entering an exemplary smart contract which allows withdrawal of up to a maximum amount of tokens or acquiring an Ethereum Request-for-Comments #20 (ERC-20) token allowing a Service Provider to receive a maximum number of tokens associated with the user to a Service Provider wallet associated with the Service Provider. In an exemplary embodiment, an exemplary Service Provider may have a Service Provider account (SPA) 114 on cryptocurrency network 110. In an exemplary embodiment, an exemplary user may allow Service Provider's SPA to withdraw a limited among of token from their wallet by using “approve” function in ERC-20. In an exemplary embodiment, this may entail one or more of ERC-20 tokens such as USDC, Tether USD, Shiba Inu, Binance USD, etc.

In another exemplary embodiment, entering a smart contract may comprise generating the smart contract, on the crypto-currency network, allowing cryptocurrency network 110 to transfer a maximum number of tokens from a user's wallet to a Service Provider wallet 124 associated with the Service Provider.

In an exemplary embodiment, generating the smart contract may further comprise of accessing terms of the agreement of the smart contract, utilizing a user device, then inputting acquiescence to the agreement utilizing the user device, and recording the smart contract on a ledger on the crypto-currency network.

In an exemplary embodiment, user device 104 may be utilized to enter into an exemplary smart contract, whether by acquisition of an ERC-20 token or entering a specific exemplary smart contract complying with terms as defined above.

In an exemplary embodiment, method 300 may further comprise of step 304, which may comprise of entering another smart contract between a merchant and the service provider account. In an exemplary embodiment, entering another smart contract between a merchant and service provider account may entail entering a smart contract where a merchant may receive crypto tokens from an exemplary service provider account. Accordingly, in an exemplary embodiment, when an exemplary transaction occurs at a merchant, a merchant is assured that based on an exemplary another smart contract, an exemplary merchant account will be eventually settled at the time of settlement.

In an exemplary embodiment, method 300 may further comprise of step 306, which may comprise of receiving, at one or more processors associated with a Service Provider, from one or processors associated with a merchant, a request from the merchant to approve an amount for a transaction. In an exemplary embodiment, step 306 may be conducted similarly to step 204 of FIG. 2.

In an exemplary embodiment, method 300 may further comprise of step 308, which may comprise of determining, by the one or more processors associated with the service provider, by the one or more processors, whether to approve the amount for the transaction based on spending power associated with the user. In an exemplary embodiment, the spending power may be calculated as a wallet balance associated with a user minus a card balance associated with the user. In an exemplary embodiment, step 308 may be conducted similarly to step 206 of FIG. 2.

In an exemplary embodiment, method 300 may further comprise step 310. In an exemplary embodiment, step 310 may comprise of approving, utilizing the one or more processors associated with the Service Provider, the request from the merchant based on the determined approval. That is, if the amount associated with the request is less than a spending power associated with the user, as calculated by SP processor, an exemplary transaction may be approved. In an exemplary embodiment, step 310 may be conducted similarly to step 208 of FIG. 2.

In an exemplary embodiment, method 300 may further comprise of step 312, which may comprise of updating, utilizing the one or more processors, the card balance associated with the user and a merchant account balance, based on approving the amount for the transaction. In an exemplary embodiment, step 312 may be conducted similarly to step 210 of FIG. 2.

In an exemplary embodiment, method 300 may further comprise of step 312. In an exemplary embodiment, step 314 may comprise forwarding a new transaction request and another transaction request to the crypto-currency network, from the one or more processors associated with the Service Provider, to execute the smart contract and the another smart contract. In an exemplary embodiment, an exemplary new transaction request and the another transaction request may be transmitted simultaneously, or may be sent one-by-one. In an exemplary embodiment, the another transaction request may be forwarded first, and then the new transaction requested may be forwarded. Similarly, the new transaction request and the another transaction request may be executed simultaneously or in-series.

In an exemplary embodiment, there may be additional requests associated with various user and additional another requests associated with various other merchants. In an exemplary embodiment, first accounts related to merchants may be settled, and then accounts settled with users may be settled.

As an exemplary scenario, forwarding a new request may entail forwarding a new transaction request to the crypto-currency network 110, from SP processors 122, to execute the smart contract, wherein executing the smart contract comprises transferring a quantity of tokens corresponding to the amount of the user balance from the user's wallet 106 to SPA 114.

Similarly, for another transaction request, an exemplary merchant balance may be transferred from SPA 114 to merchant wallet 116.

In an exemplary embodiment, SP processors 122 may be configured to (based on software encoded within memory/databases of SP environment 120) to conduct step 214. Accordingly, SP processors 122 may forward a transaction request to crypto currency network 110 based on a pre-defined period or explicit instructions received from SP processor 122.

In an exemplary embodiment, method 300 may further comprise of step 316, which may comprise initiating a token transfer and another token transfer, on the cryptocurrency network, by executing the smart contract and the another smart contract. In detail, step 316 may comprise of initiating a token transfer and withdrawing, on the crypto-currency network, the quantity of the tokens corresponding to the user balance from the user's wallet 106 to SPA 114 and updating ledger 112 on crypto-currency network 110.

Furthermore, this may entail initiating another token from the SPA 114 to merchant wallet 116 and updating ledger 112 on crypto-currency network.

In further detail, in an exemplary embodiment, SP Processor 122 may initiate a fund transfer on-chain, that is conduct the exchange that was enabled in steps 202 and 204. In an exemplary embodiment, a fund transfer on-chain may be initiated using Ehters.js lib and infura. In an exemplary embodiment, Ethers.js lib may refer to a JavaScript library that is used in off chain codebase. In an exemplary embodiment, using it enables off chain code to communicate with blockchain such as reading account balance and transfer assets to another account. In an exemplary embodiment, off chain codebase may be stored within SP Environment 120. In an exemplary embodiment, in order for ethers.js to work with blockchain, it needs node provider like Infura. IN an exemplary embodiment, Infra runs nodes that is part of blockchain so it can do read/write operation. Programmer can enter Infura credential to ethers.js, pay Infura for read/write operations.

In an exemplary embodiment, exemplary withdrawing am amount may be performed utilizing “transferForm” function in ERC-20. In an exemplary embodiment, one or more computers within cryptocurrency network 110 may execute the “transferFrom” function. Accordingly, by execution of exemplary smart contracts, tokens are transferred or the right to have them transferred is provided to an exemplary SPA associated with an Service Provider, such as SPA 114 and Service Provider associated with SP processors 122.

In an exemplary embodiment, updating a ledger on the crypto-currency network may refer to one or more computers within cryptocurrency network 110 updating a ledger, such as cryptocurrency ledger 112.

In an exemplary embodiment, one more processors associated with an Service Provider, such as SP processors 126, may determine that a transaction has occurred or in exemplary embodiments, that a transaction will occur based on a smart contract or an Service Provider Account, and therefore, update information related to a particular user and corresponding SP account on SP databases 126. This may include, amount of corresponding tokens committed to Service Provider, for example, based on token stored at SPA 114 or based on smart contracts. Accordingly, SPA processors 122 may continue to approve or deny transactions requests based on information included within SP databases 126.

In an exemplary embodiment, approvals from SP processors 122 may be sent on data related to SPA 114 and specific users. In such exemplary instances, settlements between user wallet 106 and SPA 114 may occur on a periodical basis, that is, daily, weekly, monthly, or another specified amount of time. In an exemplary embodiment, they may occur when a certain transaction threshold is determined by SP processors 122 based on Service Provider set parameters (which may be stored within SP databases 126). Accordingly, in an exemplary embodiment, transfer of ERC-20 tokens related to multiple transactions may happen concurrently saving “gas” within cryptocurrency network 110.

In an exemplary embodiment, payment settlements between an exemplary merchant and exemplary Service Provider may occur at the end of a given time. For example, payment settlement may occur at the end of the given time (e.g. the end of the day).

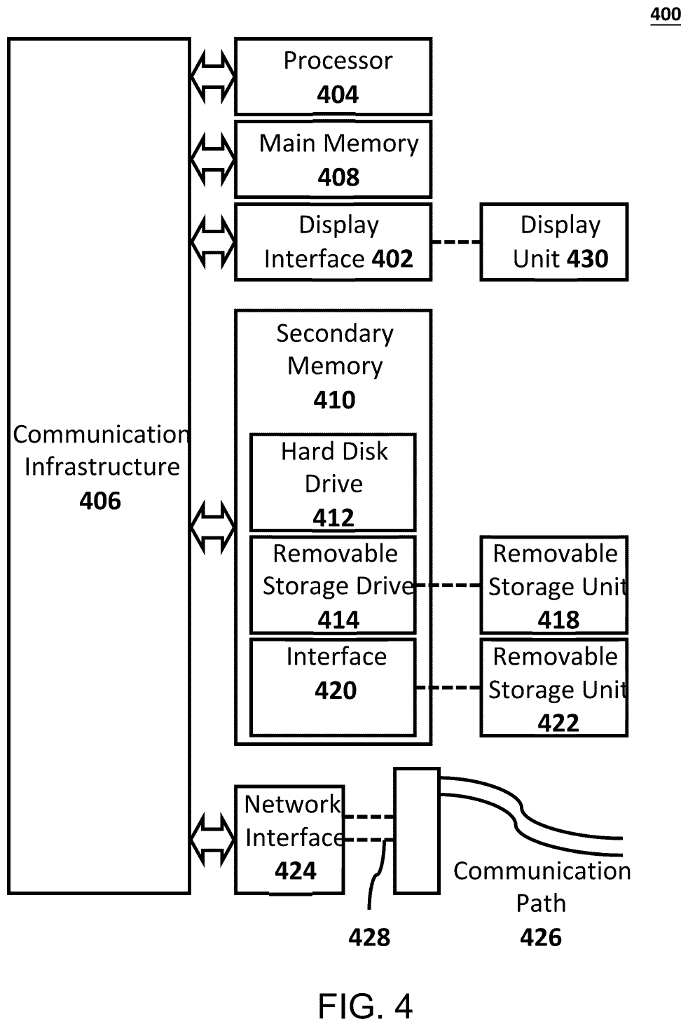

FIG. 4 depicts a block diagram of an example computer system 400 in which various of the embodiments described herein may be implemented. In an exemplary embodiment, system 400 may represent any exemplary computer utilized within system 100, including but not limited to, within cryptocurrency network 110, within elements of SP environment 120, and within various elements of financial institutions environment 130. The computer system 400 includes a bus 402 or other communication mechanism for communicating information, one or more hardware processors 404 coupled with bus 402 for processing information. Hardware processor(s) 404 may be, for example, one or more general purpose microprocessors.

The computer system 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions. For enhanced security, in some embodiments storage at a UNode is embodied in ROM only.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor (e.g., via a touch enabled smartphone).

The computing system 400 may include a user interface component to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Other embodiments incorporating various modifications and alterations may be used in the design and manufacture of the apparatus consistent with exemplary embodiments of the present disclosure without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “front”, “back”, “vertical”, “horizontal”, “up”, “down”, and “side-to-side” are used in a relative sense to the normal orientation of the apparatus.

What is claimed:

1. A method for settling cryptocurrency transactions, comprising:
entering a smart contract, on a crypto currency network, between a user and a service provider account (SPA);
entering another smart contract, on the crypto currency network, between a merchant and the SPA;
receiving, at one or more processors associated with a Service Provider, from one or processors associated with a merchant, a request from a merchant to approve an amount for a transaction;
determining, by the one or more processors associated with the service provider, whether to approve the amount for the transaction based on spending power associated with the user, the spending power calculated as a wallet balance associated with a user minus a card balance associated with the user;
approving, utilizing the one or more processors associated with the Service Provider, the request from the merchant based on the determined approval;
updating, utilizing the one or more processors, the card balance associated with the user and a merchant account balance, based on approving the amount for the transaction;
forwarding a new transaction request and another transaction request to the crypto-currency network, from the one or more processors associated with the Service Provider, to execute the smart contract and the another smart contract; and
initiating a token transfer and another token transfer, on the cryptocurrency network, by executing the smart contract and the another smart contract.

2. The method of claim 1, further comprising updating a ledger on the crypto-currency network.

3. The method of claim 2, wherein:
initiating the token transfer comprises initiating the token transfer, on the cryptocurrency networking, by executing the smart contract, wherein executing the smart contract comprises transferring a quantity of tokens corresponding to the user's card balance from the user's wallet; and
initiating another token transfer comprises initiating the another token transfer, on the cryptocurrency network, by executing the another smart contract, wherein executing the another smart contract comprises transferring another quantity of tokens corresponding to the merchant account balance to a merchant wallet.

4. The method of claim 3, wherein initiating the another token transfer occurs before initiating the token transfer.

5. The method of claim 1, entering the smart contract comprises:
acquiring an Ethereum Request-for-Comments #20 (ERC-20) token allowing the Service Provider account (SPA) to receive a maximum number of tokens associated with the user to the SPA.

6. The method of claim 5, entering the smart contract comprises:
generating the smart contract, on the crypto-currency network, allowing the transfer of a maximum number of tokens from a user's wallet to an Service Provider wallet associated with the Service Provider.

7. The method of claim 6, wherein generating the smart contract comprises:
accessing terms of the agreement of the smart contract, utilizing a user device; and
inputting acquiescence to the agreement utilizing the user device; and
recording the smart contract on a ledger on the crypto-currency network.

8. The method of claim 1, wherein the card balance comprises a cumulative total of unsettled transactions associated with the user.
